(19) United States
(12) Patent Application Publication
(10) Pub. No.: US 2008/0177787 A1
(43) Pub. Date: Jul. 24, 2008

(54) FACILITATION OF ELECTRONIC PRESCRIPTION REQUESTS

(75) Inventors: Murali M. Karamchedu, Beaverton, OR (US); Jeffrey B. Sponaugle, Tigard, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: KRYPTIQ CORPORATION, Hillsboro, OR (US)

(21) Appl. No.: 11/625,090

(22) Filed: Jan. 19, 2007

(51) Int. Cl. G06F 17/30; G06Q 50/00

(52) U.S. Cl. 707/104.1; 705/2; 707/E17.009

(57) ABSTRACT

Embodiments of the present invention provide methods and systems for facilitating electronic requests for prescriptions among healthcare providers and pharmacies. Other embodiments may be described and claimed.

### TECHNICAL FIELD

Embodiments of the present invention relate to the field of data processing, and more particularly, to facilitating electronic requests for prescriptions among healthcare providers and pharmacies.

### BACKGROUND

As advances in information technology are continually made, greater efficiencies and speed may be realized for many industrial and business processes. This is true for many industries including the healthcare industry. In the healthcare industry, more and more communications are being performed electronically. The ability to electronically request prescriptions is currently available. However, many healthcare providers and/or pharmacies are too small, or are not technologically savvy, to effectively use current technology for prescriptions.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates a system for facilitating electronic requests for prescriptions, in accordance with various embodiments of the present invention; and

FIG. 2 schematically illustrates an exemplary embodiment of a server that may be utilized to facilitate electronic requests for prescriptions, in accordance with various embodiments of the present invention.

### DETAILED DESCRIPTION OF THE DRAWINGS

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and systems for facilitating electronic requests for prescriptions among healthcare providers and pharmacies.

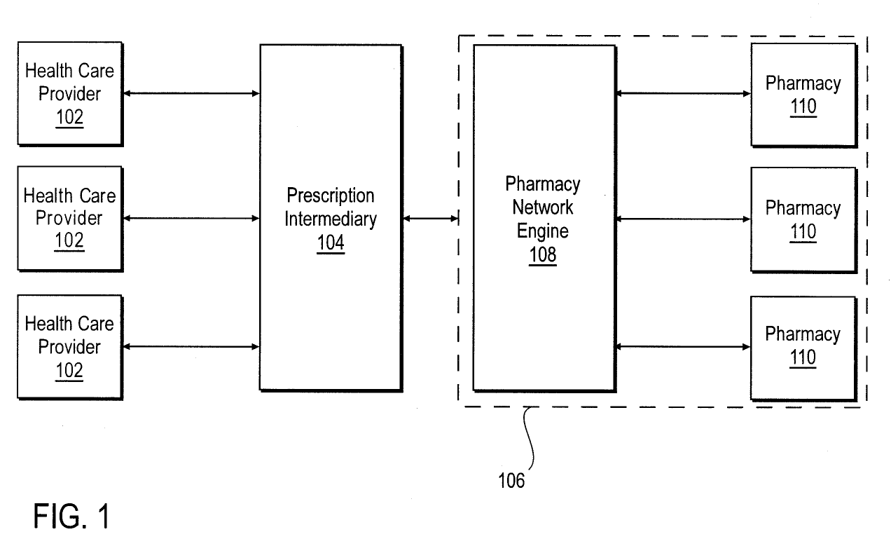

With reference to FIG. 1, in accordance with various embodiments of the present invention, a plurality of health care providers 102 are communicatively coupled to a prescription intermediary 104, which in turn is communicatively coupled to a pharmacy network 106. In accordance with various embodiments of the present invention, pharmacy network 106 includes a pharmacy network engine 108 that is communicatively coupled to a plurality of pharmacies 110. An example of a pharmacy network engine 108 is SureScript®, 5971 Kingstowne Village Parkway, Suite 200, Alexandria, Va. 22315. In accordance with various alternate embodiments of the present invention, the prescription intermediary 104 may be directly coupled to the pharmacies and thus, the pharmacy network 106 may not include a pharmacy network engine. As used herein, the phrase “pharmacy network” generally refers to pharmacies that may electronically receive requests for prescriptions to be filled and thus, the phrase “pharmacy network” should not be construed in a more limiting manner.

The prescription intermediary 104, in accordance with various embodiments of the present invention, may maintain electronic mailboxes for the healthcare providers 102 such that in general, a particular electronic mailbox corresponds to a particular healthcare provider. Messages for healthcare providers may be received at the electronic mailboxes and then may be forwarded by the prescription intermediary 104 to the appropriate healthcare provider or may be retrieved by the appropriate healthcare provider. The mailboxes may also be used by the healthcare providers to forward messages to the prescription intermediary. Examples of messages include, but are not limited to, updates regarding various aspects and information concerning the healthcare providers and/or the pharmacies, requests for prescriptions, etc.

Generally, in accordance with various embodiments of the present invention, patients of healthcare providers may have a patient identification (ID) assigned to them. Additionally, each healthcare provider 102 may have an identification (ID), in accordance with various embodiments of the present invention. Each healthcare provider 102 may be a group of providers, wherein each group in turn includes multiple, individual healthcare providers, i.e., doctors, nurses, etc., and thus, each individual healthcare provider may be assigned a healthcare provider ID.

In accordance with various embodiments of the present invention, a healthcare provider 102 may forward a request for filling a prescription to the prescription intermediary 104. Generally, the request may be in the form of an email and include a specific pharmacy 110 to which the request should be routed. The prescription intermediary, in accordance with various embodiments, processes and forwards the request to the pharmacy network and on to the appropriate pharmacy. As part of the processing, the prescription intermediary may transform the request into an electronic format required by the pharmacy network engine 108 of pharmacy network 106. In various embodiments, the prescription intermediary may extract the relevant information, e.g. health care provider, patient, drug name, dosage, and so forth, from the received request, and may generate network compliant message packets based on the extracted information and in accordance with the electronic prescription submission protocol of the pharmacy network.

In accordance with various embodiments of the present invention, during processing, the prescription intermediary 104 may also verify that the particular pharmacy 110 to which the request is directed is indeed a member of the pharmacy network 106. In various embodiments, this may be accomplished by maintaining, for the healthcare provider, a database of pharmacies that have been previously used by the healthcare provider, thereby essentially mapping pharmacies in a geographical area that are part of the pharmacy network. If a pharmacy is not listed within the database, in accordance with various embodiments of the present invention, the prescription intermediary may automatically add the pharmacy to the pharmacy database based upon an assumption that it is a member of the pharmacy network since the healthcare provider is requesting that the prescription be filled by that particular pharmacy. The prescription intermediary may, in accordance with various embodiments, verify that a particular pharmacy not within the pharmacy database is a member of the pharmacy network and thus is able to accept electronic requests for prescriptions by contacting the pharmacy itself. Upon verification, the prescription intermediary may add the pharmacy to the pharmacy database for the healthcare provider.

Often a prescription may be able to be refilled by a pharmacy 110 without authorization from a healthcare provider. Some prescriptions, whether refillable or not, may be renewed with authorization from the healthcare provider that provided the prescription. Thus, a patient may attempt to have a prescription “refilled” at a pharmacy when there are no refills available. In accordance with various embodiments of the present invention, the pharmacy 110 at which the patient is attempting to obtain a refill may forward a request for a refill prescription to be filled to the prescription intermediary 104, which may then contact the healthcare provider that provided the original prescription and seek authorization for the refill. Upon receiving authorization or denial from the healthcare provider, the prescription intermediary may inform the pharmacy, directly or through the pharmacy network engine 108 of the pharmacy network of which the pharmacy is a member, in accordance with various embodiments. The refill request from the pharmacy may be in a form of an email, a voice message, a facsimile, a short messaging service (SMS) or a multimedia messaging service (MMS) message. Likewise, the notification transmitted to the healthcare provider may be in a form of an email, a voice message, a facsimile, a SMS or a MMS message. The two forms may be the same or different.

In various embodiments, the prescription intermediary also receives the authorization or rejection of the refill from the healthcare provider, and forwards in substance the authorization or rejection to the pharmacy. The authorization or rejection from the healthcare provider may be in a form of an email, a voice message, a facsimile, a SMS or a MMS message. Likewise, the authorization or rejection transmitted to the healthcare provider may be in a form of an email, a voice message, a facsimile, a SMS or a MMS message. The two forms may be the same or different.

Whenever a request for a prescription to be filled or renewed passes through the prescription intermediary 104, in accordance with various embodiments of the present invention, the prescription intermediary may verify the patient ID and/or the healthcare provider ID. If there is a problem with either of the IDs, the prescription intermediary 104 may inform an administrator at the appropriate healthcare provider 102. In accordance with various embodiments, this may be done through the electronic mailbox. Likewise, in accordance with various embodiments, the administrator at the healthcare provider may use the mailbox to inform the prescription intermediary of changes with regard to, for example, a change in doctors for a particular patient. Thus, for example, the prescription intermediary may update within its database the appropriate healthcare provider ID and patient ID, with respect to a particular prescription, based upon changes received from the administrator. Likewise, for example, in accordance with various embodiments, the administrator may inform the prescription intermediary 104 that all patients and/or prescriptions associated with a particular healthcare provider ID are now associated with a different healthcare provider ID.

In accordance with the various alternate embodiments of the present invention, some healthcare providers 102 may not have electronic mail and thus, may communicate with the prescription intermediary 104 via alternative methods such as, for example, telephony, facsimile, SMS or MMS. In accordance with various embodiments, the prescription intermediary may thus, for example, receive a voice message, a facsimile, a SMS or a MMS request for a prescription to be filled from a healthcare provider and may then manually or automatically (through voice and/or character recognition etc) generate one or more electronic messages comprising in substance the prescription to be forwarded to the pharmacy network. Likewise, in accordance with various embodiments, the prescription intermediary may receive an electronic mail from a pharmacy for a request to have a prescription refilled and may thus forward the request to the appropriate healthcare provider via voice messages, facsimile, SMS or MMS messages.

In accordance with various embodiments of the present invention, the prescription intermediary 104 may also facilitate the request for prescriptions between the healthcare providers and the pharmacies by providing confirmations, where desired or appropriate, to the healthcare providers and the pharmacies.

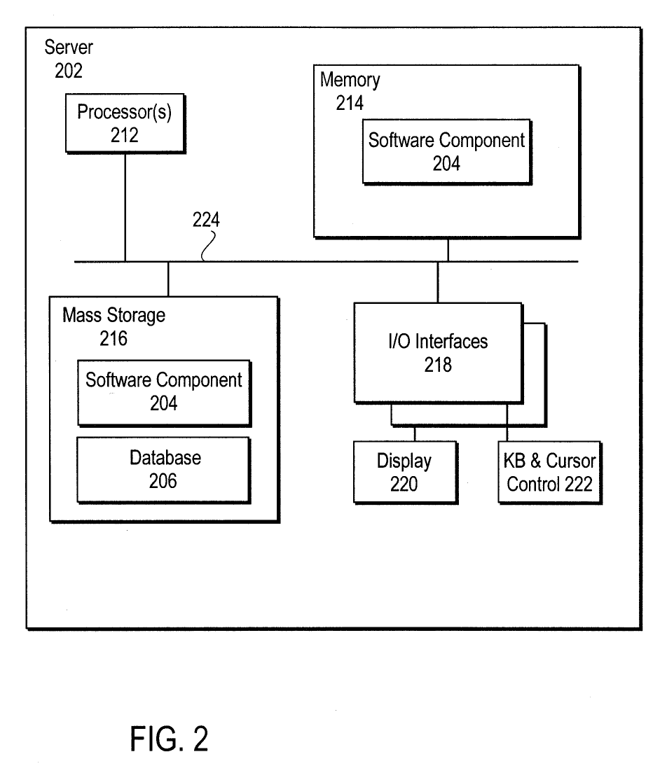

FIG. 2 illustrates an example implementation of a server 202, one or more of which may be used to implement a prescription intermediary 104, in accordance with various embodiments of the present invention. As illustrated, server 202 may include digital computing processor 212 and memory 214 coupled to each other via bus 224. Further, device 212 may include mass storage device 216, I/O interfaces 218, and a number of I/O devices coupled to each other and the earlier described elements as shown. Memory 214 and mass storage device 216 may include in particular, a transient and a persistent copy of software component 204, respectively. Software component 204 may be used to implement one or more of the functions of the prescription intermediary previously described. Mass storage device 216 may further include one or more databases 206. The I/O devices may include in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of Scotts Valley, Calif.

In various embodiments, I/O interfaces 218 include a communication interface for operatively coupling server 202 to healthcare providers 102 and pharmacy network 106. The server may be directly coupled to the pharmacies of the pharmacy network or may be indirectly coupled to the pharmacies via pharmacy network engine 108. The communication interface may be a wire based or wireless interface, coupling server 202 to the healthcare providers and the pharmacy network via a wired/wireless local/wide area network. An example of a suitable wired network interface includes but is not limited to an Ethernet interface, and an example of a suitable wireless network interface includes, but is not limited to, an IEEE 802.11b (working group) network interface.

Except for software component 204 (which may provide some or all of the functions for a prescription intermediary 104 as described herein), elements 202, 206, 212, 216, 218, 220 and 222, and the manner these elements are employed, each of these elements represents a broad range of the corresponding elements known in the art or to be designed, consistent with the teachings of the present invention. The elements perform their conventional functions, i.e. processing, storage, reading, displaying, and so forth.

Those skilled in the art will understand that software component 204 may comprise multiple parts for performing the prescription intermediary 104 functions and that all parts may be centrally located on one or more servers. Alternatively, one or more parts of software component 204 may reside locally at a healthcare provider and/or a pharmacy and/or another remote location.

While for ease of understanding, server 202 is “singularly” illustrated, in various embodiments, server 202 may be a single computing device, a cluster of tightly coupled computing devices, or networked computing devices.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to program an apparatus to enable the apparatus to perform one or more of the prescription intermediary functions disclosed herein.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
receiving, by a prescription intermediary, from a health care provider, first one or more messages comprising a prescription destined for a pharmacy, the first one or more messages being in a first form; and
generating and transmitting electronically, by the prescription intermediary, second one or more messages comprising in substance the prescription to an engine of a pharmacy network of which the pharmacy is a member, the second one or more message being in a second form, that is different from the first form, and the generation and transmission being performed in accordance with an electronic prescription submission protocol of the pharmacy network.

2. The method of claim 1, wherein the first form is a selected one of voice, email, facsimile, SMS or MMS.

3. The method of claim 1, further comprising verifying, by the prescription intermediary, a patient identification associated with the prescription.

4. The method of claim 3, further comprising informing, by the prescription intermediary, an administrator associated with the healthcare provider whether there is a problem with the patient identification.

5. The method of claim 1, further comprising maintaining, by the prescription intermediary, at least one database of pharmacies previously used by a healthcare provider for prescriptions and adding the pharmacy to the database if it is not in the database.

6. The method of claim 5, wherein adding the pharmacy to the database if it is not on the database comprises automatically adding the pharmacy to the database.

7. The method of claim 1, further comprising monitoring, by the prescription intermediary, electronic mailboxes for healthcare providers and forwarding in substance any electronic messages within an electronic mailbox to an appropriate healthcare provider.

8. The method of claim 7, wherein said forwarding in substance comprises transferring content of an electronic message into a voice message, a facsimile, a SMS or a MSS message for the healthcare provider.

9. The method of claim 1, further comprising monitoring, by the prescription intermediary, a healthcare provider identification associated with the prescription.

10. The method of claim 9, further comprising receiving, by the prescription intermediary, information relating to a healthcare provider's identification and updating a healthcare identification database with the information.

11. A system comprising:
a server configured to:
receive from a pharmacy a request for refilling a prescription destined for a healthcare provider; and
forward the request for refilling a prescription at least in substance to the healthcare provider.

12. The system of claim 11, wherein the received request is in a form selected from an email, a voice message, a facsimile, a SMS or a MMS message.

13. The system of claim 12, wherein the forwarded request is in the same selected form or in a different selected form.

14. The system of claim 11, wherein the server is further configured to verify a patient identification associated with the prescription.

15. The system of claim 14, wherein the server is further configured to inform an administrator associated with the healthcare provider whether there is a problem with the patient identification.

16. The system of claim 11, wherein the server is further configured to verify that the pharmacy is a member of a pharmacy network.

17. The system of claim 11, wherein the server is further configured to maintain mail or voice boxes for healthcare providers, to monitor the mail or voice boxes for the healthcare providers and to forward any messages in substance within a mail or voice box to an appropriate healthcare provider.

18. The system of claim 11, wherein the server is further configured to monitor a healthcare provider identification associated with the prescription.

19. The system of claim 18, wherein the server is further configured to receive information relating to a healthcare provider's identification and to update a healthcare identification database with the information.

20. The system of claim 11, wherein the server is further configured to receive an authorization or a rejection of the refill from the healthcare provider, and to forward at least in substance the authorization or rejection to the pharmacy.

21. The system of claim 20, wherein the received authorization or rejection is in a form selected from an email, a voice message, a facsimile, a SMS or a MMS message.

22. The system of claim 21, wherein the forwarded authorization or rejection is in the same selected form or in a different selected form.

23. An article of manufacture comprising:
a storage medium; and
a plurality of instructions stored therein;
wherein the plurality of instructions are adapted to cause one or more processors to perform a plurality of prescription intermediary operations, the plurality of operations comprising:
receiving a request for filling a prescription;
verifying at least one of a patient identification, a healthcare provider or a pharmacy associated with the prescription; and
forwarding the request for filling a prescription to an entity for handling with respect to the request for filling a prescription.

24. The article of manufacture of claim 23, wherein the request for filling a prescription is a request to renew a prescription, the receiving comprises receiving the request from a pharmacy, and the forwarding comprises forwarding the request to a healthcare provider.

25. The article of manufacture of claim 23, wherein the request for filling a prescription is a new prescription, the receiving comprises receiving from a healthcare provider, and the forwarding comprises forwarding to a pharmacy directly or indirectly via an engine of a pharmacy network of which the pharmacy is a member.

26. The article of manufacture of claim 26, wherein forwarding the request for filling a prescription to an entity for handling comprises forwarding the request to a healthcare provider via electronic mail.
